(19) United States
(12) Patent Application Publication
(10) Pub. No.: US 2020/0170088 A1
(43) Pub. Date: May 28, 2020

(54) Load-switch voltage control circuit

(71) Applicant: Mihail S. Moisin, Rockport, MA (US)

(72) Inventor: Mihail S. Moisin, Rockport, MA (US)

(21) Appl. No.: 16/350,522

(22) Filed: Nov. 28, 2018

(51) Int. Cl. H05B 41/298; H05B 41/392

(52) U.S. Cl. CPC H05B 41/2983; H05B 41/3921

(57) ABSTRACT

A load-switch voltage control circuit includes a power control circuit for controlling a switching element that stabilizes the voltage to a load. The power control circuit determines intervals of conduction for the switching element, that connects a control impedance to the load, for stabilizing the voltage across the load.

### STATEMENT REGARDING FEDERALLY SPONSORED RESEARCH

Not Applicable.

### FIELD OF THE INVENTION

The present invention relates generally to electrical circuits and, more particularly, to electrical circuits for controlling Voltage to a load.

### BACKGROUND OF THE INVENTION

As is known in the art, there are a variety of circuits that limit the energy delivered to a load. For example, dimming circuits for lighting applications adjust the brightness of a light source. Exemplary power control, dimming, and/or feedback circuits are shown and described in U.S. Pat. Nos. 5,686,799; 5,691,606; 5,798,617; 5,955,841; and 7,099,132 all of which are incorporated herein by reference.

However, known power control/dimmer circuits typically operate out of a source of constant voltage supply.

There are applications where, especially in the Power Generation field in general and in the Green Power Generation field in particular, where the generated Voltage is not constant but depends on the electrical Load. As the load gets lighter, the generated Voltage increases, sometimes to unacceptable levels, transients or peaks.

### SUMMARY OF THE INVENTION

The present invention provides a voltage management circuit that eliminates the over-voltage, transients and peak-voltages by electronically switching or adjusting the electric load, in a system or application where the generated supply voltage is variable.

Such an example is a Green Power Generation application, where energy is extracted from a natural gas pipe line under pressure, by passing the stream of natural gas through an Air-Motor connected to an Electric Generator, or a Motor-Gen group.

An electric load is connected to this Motor-Gen group, for supplying the energy needs of remote natural gas distribution and control centers in the field, that otherwise do not have access to any off the grid power lines.

While the invention is primarily shown and described in conjunction with circuits connected to a Motor-Gen group for energizing electric loads, it is understood that the invention is applicable to circuits for energizing loads in general in which it is desirable to provide voltage control, as well as overvoltage and consequently current surge protection.

In one aspect of the invention, a voltage control circuit includes a switching element coupled between one end of the electric load and one end of a control impedance. A voltage control circuit biases the switching element to a non-conductive state for a portion of an AC half cycle during which a peak voltage of the AC half cycle occurs when a voltage across the first and second rails is smaller than a predetermined threshold. Conversely, the voltage control circuit biases the switching element to a conductive state for a portion of an AC half cycle whenever the voltage of the AC half cycle occurs when a voltage across the first and second rails is higher than a predetermined threshold.

In another aspect of the invention, the circuit includes a voltage transient sensing circuit coupled to the voltage control circuits for providing current surge and over voltage protection.

### BRIEF DESCRIPTION OF THE DRAWINGS

The invention will be more fully understood from the following detailed description taken in conjunction with the accompanying drawings, in which:

FIG. 1 is a schematic representation of a circuit having voltage control in accordance with the present invention;

FIG. 2 is a graphical display of a voltage waveform across the Load Impedance Rld, generated by the circuit of FIG. 1; and

FIG. 3 is a schematic representation of an application having a Switch-Load Voltage Control Circuit in accordance with the present invention.

### DETAILED DESCRIPTION OF THE INVENTION

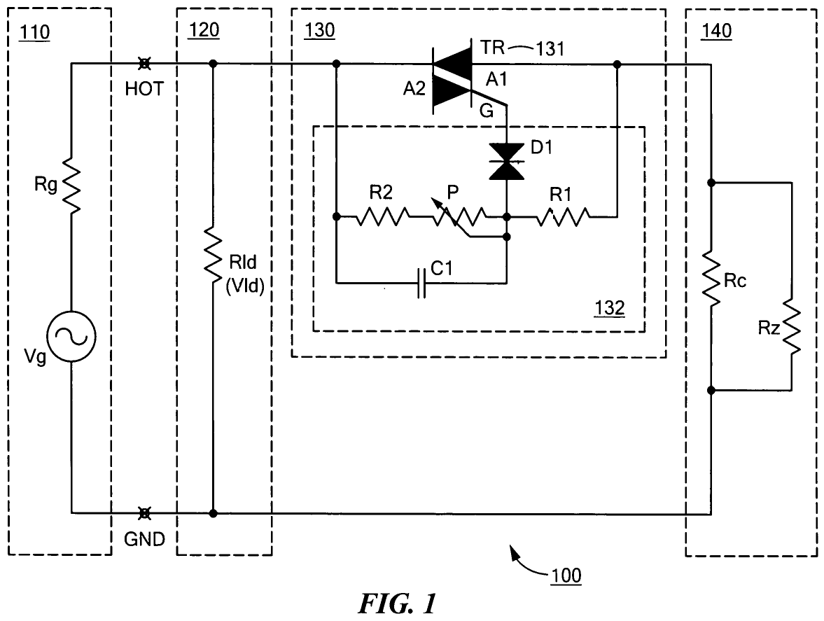

FIG. 1 shows an exemplary application of the circuit having voltage control in accordance with the present invention. The application circuit (100) includes a Voltage Generator Vg with an Internal Impedance Rg, (110), a Load Impedance Rld (120), connected between the first Input Terminal or rail (HOT) and the second Input Terminal or rail (GND), a Switching Circuit (130) connected between one Input Terminal and one end of the Control Impedance Rc (140), the other end of the Control Impedance Rc being connected to the other Input Terminal.

A switching element (131) is part of the Switching Circuit and a voltage control circuit (132) is coupled across the switching element.

In general, the voltage control circuit (132) selects conduction and non-conduction regions for the switching element (131) such that the control impedance Rc (140) is connected to or disconnected from the load impedance Rld in a dynamic fashion, for parts of the voltage cycles. This way, the static control impedance Rc effectively becomes a dynamic impedance, operating between two extreme values, the two value limits being given by the continuous connection or continuous disconnection between Rc and Rld, operated by the switching element.

The switching element (131) is shown as a TRIAC (TR), having three terminals A1, G and A2. It will be readily understood by one of ordinary skill in the art that a wide

variety of switching devices, like Bipolar Junction Transistors (BJTs) or Field Effect Transistors (FETs), can be used in other embodiments to meet the requirements of this particular application. A voltage divider made out of two impedances R1, R2 and a Potentiometer P is connected between terminals A1 and A2 of the switching element TR, with a Diac (D1) connected between the mid-point of the voltage divider R1 and R2 connected to the Potentiometer P, and Triac terminal G.

A capacitor C1, or any other suitable impedance, could optionally be connected across resistor R2 and potentiometer P, to help detect the voltage transients and consequently operate the switching element to direct the transient energy into the Transient Suppression Element Rz, as part of the control impedance (140).

As the circuit operates to connect and energize the control impedance Rc, the switching element 131 is biased to the conductive state by a potential applied to the gate terminal G by the instantaneous voltage developed across impedance R1, which in turn fires the Diac D1, whenever this voltage reaches the Diac's breakdown voltage, which defines a threshold voltage (Vth) between the two Input Terminals.

This causes the switching element to transition to the conductive state and naturally stay in that state, in case the switching element is a Triac, until the end of the voltage half-cycle. At the end of the half-cycle the switching element will naturally turn OFF (non-conductive state), repeating the scenario described above for the next half-cycle.

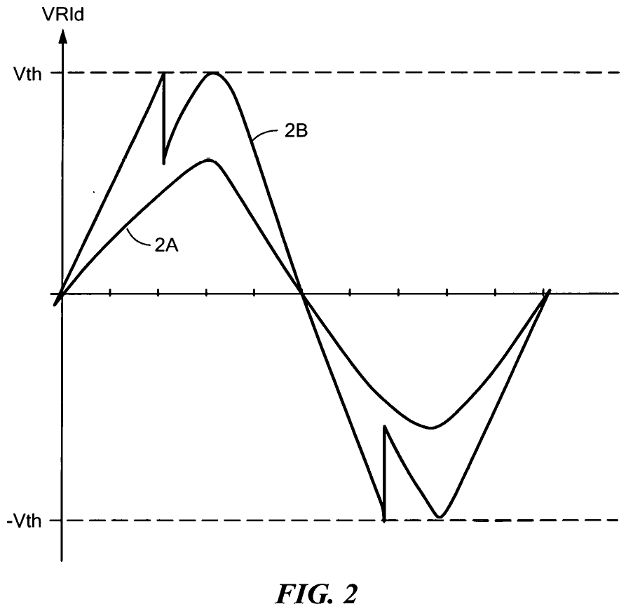

FIG. 2 is a graphical representation of the voltage waveform across the Load Impedance Rld, with respect to a threshold voltage Vth, set in any particular application. The ratio of the impedances R1, R2/P, C1, combined with the value of the breakdown voltage of the Diac switch D1, defines a Threshold Voltage (Vth) across the two rails, Hot and GND terminals. The value of this Threshold Voltage is obviously being set above the typical steady state value of the load operating voltage (Vld) but, as a safety precaution, below the maximum acceptable value of the load voltage (Vldmax) (Vld<Vth<Vldmax).

For as long as the Load Voltage (Vld) is less than the set Threshold Voltage (Vth) (Vld<Vth), the switching element TR (131) remains in a non-conductive state, keeping the Control Impedance (140) electrically disconnected from the Load Impedance Rld. This load voltage (VRld) is reflected in the 2.A waveform representation in FIG. 2.

Whenever the Load Impedance becomes lighter, like in situations when electric consumers get disconnected, the Load Voltage (Vld) tends to increase, primarily because of the Generator Internal Impedance (Rg). Whenever this instantaneous Load Voltage tends to exceed the Threshold Voltage (Vth), the switching element TR will switch into a conductive state, connecting the control impedance (Rc) in an electrical connection with the Load Impedance (Rld). Even though, in this particular embodiment, the two impedances are electrically connected in parallel, it will be readily understood by one of ordinary skill in the art that a wide variety of electrical connections can be devised, in order to achieve a similar effect.

By means of instantaneously connecting the control impedance (Rc) to the load impedance (Rld), the electric generator effectively gets instantaneously ‘loaded’ during the portion of the half cycle when the two impedances are connected together, and the voltage across the load impedance (Rld) is effectively clamped or controlled, staying in the range of the threshold voltage (Vth). This is reflected in the 2.B waveform representation in FIG. 2. This instantaneous connection also prevents large voltage transients across the load.

Since the voltage control circuit (132) selects conduction and non-conduction regions of each half-cycle for the switching element (131), the control impedance Rc (140) is connected to or disconnected from the load impedance Rld in a dynamic fashion, for parts of the voltage cycles. This way, the static control impedance Rc effectively becomes a dynamic impedance, with an effective value determined by the duration of electrical connection between Rc and Rld, throughout the voltage cycle.

Ideally, the Control Impedance (140) should be close in value to the nominal Load Impedance (120), in order to be able to perform an effective voltage control in the extreme case of all consumers (Load Impedance) being disconnected or removed.

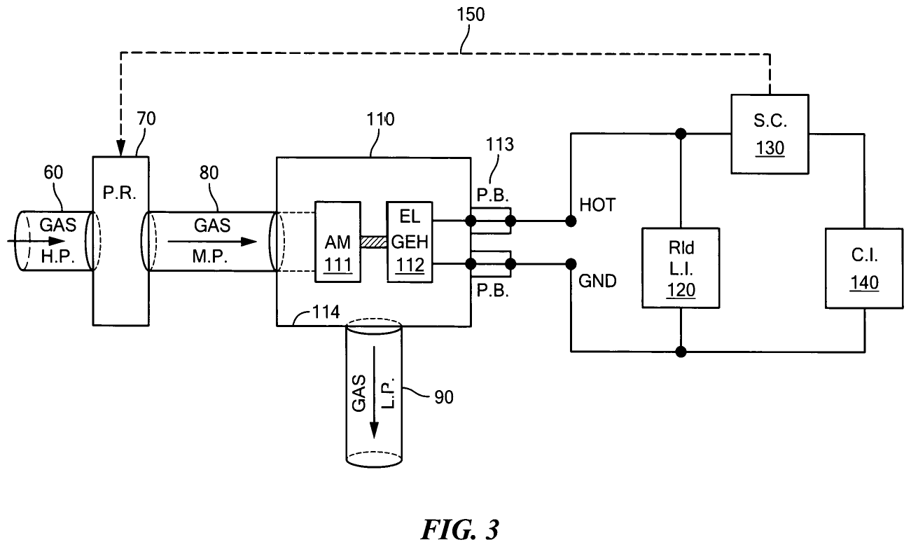

FIG. 3 is a schematic of a typical field application, where Green Energy is generated by recuperating the energy stored in high pressure natural gas pipes.

Usually this energy is being lost in the process of decompressing high pressure natural gas, decompression required for local natural gas distribution.

High Pressure natural gas pipe (60) (Gas H.P.) usually passed through a pressure regulator (70) (P.R.), into a Medium Pressure gas pipe (80) (Gas M.P.), then into a Motor-Gen group (110), made out of at least one Air-Motor (111) (A.M.) and at least one Electric-Generator (112) (E.G.), mechanically coupled together.

This whole assembly is contained in an explosion proof cylinder (114), whenever the natural gas is the agent that operates the Motor-Gen group. Medium Pressure gas flowing through the gas pipe inside the cylinder, connected to the Air-Motor (A.M.), rotates the rotor inside the A.M., generating enough torque to mechanically operate the Electric-Generator (E.G.), which in turn generates enough electricity to energize the Load Impedance (Rld).

After decompression, i.e. the gas transferred part of its energy by conversion into electricity, the resulting Low Pressure flow of gas (Gas L.P.) is directed to the local users via the low pressure pipe (90).

The electric wires from the Electric-Generator pass through the Pressure-Barrier(s) (113) (P.B.), from the Medium-Pressure environment inside the cylinder to the Ambient Pressure environment of the HOT and GND Load Terminals, connecting to the Load Impedance (L.I.) (120), Switching Circuit (130) (S.C.) and Control Impedance (Rc).

In the extreme case of all consumers (Load Impedance) being disconnected for an extended period of time, the Control Impedance Rc will be fully switched-in, as a replacement to the disconnected Load Impedance, thus keeping the circuit voltage within reasonable limits, close to the threshold voltage Vth. However, in this particular situation, in order to avoid unnecessary power dissipation across the Control Impedance Rc, the Gas Medium Pressure (Gas M.P.) could be diminished by means of an additional control, performed by means of properly operating the Pressure Regulator (P.R.). This additional control line is shown in FIG. 3 by the dotted line (150).

It is understood that the Load-Switch Voltage Control circuit shown and described above has a wide variety of applications including, but not limited to, power voltage regulators and stabilizers.

One skilled in the art will appreciate further features and advantages of the invention based on the above-described embodiments. Accordingly, the invention is not to be limited by what has been particularly shown and described, except as indicated by the appended claims.

Typical components values, for a 1000W/220V application are:

Voltage Threshold Vth=232V

R1=6.49 kOhm/0.25 W

R2=27.4 kOhm/1 W

P=10.0 kOhm/0.5 W

C=1.0nF/1kV

TR=BTA06 6A/800V (Triac)

D1=DB-32 (32V Diac)

Rc=50 Ohm/1000 W

Rz=MOV/270 Vrms

What is claimed is:

1. A load-switch voltage control circuit, comprising:
a switching element coupled between a load impedance and a control impedance; and
a voltage control circuit coupled to the switching element, wherein the control circuit biases the switching element to a conductive state for a portion of a half cycle of an AC signal for energizing the load during which a peak voltage of the AC half cycle occurs when a voltage across the first and second rails is greater than a predetermined threshold.

2. The circuit according to claim 1, wherein a duration of the switching element being in the conductive state is triggered about the threshold voltage of the AC half cycle.

3. The circuit according to claim 1, wherein the voltage control circuit includes a potentiometer for setting the predetermined voltage threshold.

4. The circuit according to claim 1, further including a transient detection impedance element for biasing the switching element to the conductive state when a voltage across the rails becomes suddenly greater than a level corresponding to the predetermined voltage threshold.

5. The circuit according to claim 1, wherein the predetermined voltage threshold is below an expected peak of the AC half cycle for providing overvoltage and transients protection.

6. The circuit according to claim 1, wherein the predetermined voltage threshold is above an expected peak of the AC half cycle, to provide full power transfer to the nominal load.

7. The circuit according to claim 1, further including adjusting the voltage threshold to provide controlling the power delivered to a load

8. The circuit according to claim 4, further including a transient suppression impedance element connected to the control impedance, for suppressing the voltage transients

9. A method of managing voltage to a load in a circuit, comprising:
selecting a voltage threshold at which an AC signal will be clamped or controlled such that a switching element for controlling an impedance to be connected to a load is biased to a conductive state during a time that the AC signal is above the voltage threshold.

10. The method according to claim 9, wherein a duration of the switching element being in the conductive state is triggered about the threshold voltage of the AC half cycle.

11. The method according to claim 9, further including selecting the threshold voltage using a potentiometer.

12. The method according to claim 9, further including setting the threshold voltage below an expected voltage peak of the AC signal to provide overvoltage protection.

13. The method according to claim 9, further including setting the threshold voltage above an expected voltage peak of the AC signal to provide full power to a load.

14. The method according to claim 9, further including adjusting the voltage threshold to provide controlling the power delivered to a load

15. A method of managing voltage to a load in a circuit, comprising:
providing a switching element to a voltage rail for energizing a load;
coupling a control circuit to the switching element;
coupling a control impedance to the switching element such that the control circuit biases the switching element to a conductive state when a voltage across the first and second rails is greater than a predetermined threshold.

16. The method according to claim 15, further including selecting the threshold voltage below an expected peak voltage of an AC signal for energizing the load to provide overvoltage protection.

17. The method according to claim 15, further including selecting the threshold voltage above an expected peak voltage of an AC signal to provide full power to a load.

18. The method according to claim 15, wherein a duration of the switching element being in the conductive state is triggered about the threshold voltage of the AC half cycle.

19. The method according to claim 15, further including selecting the threshold voltage using a potentiometer.

20. The method according to claim 15, further including adjusting the voltage threshold to provide controlling the power delivered to a load.
Withdrawn:

21. A method of generating electricity out of natural gas under pressure, by flowing a stream of natural gas through a motor mechanically connected to an electric generator.

22. The method according to claim 21, wherein no burning of natural gas is involved in the process of generating electricity.

23. The method according to claim 21, further including an explosion proof recipient that contains both the motor and electric generator in the flux of natural gas.

24. The method according to claim 21, further including at least one pressure barrier for passing the electric wires from the electric generator to the load.

25. The method according to claim 21, further including controlling the pressure of the stream of natural gas flowing through the motor
